(19) United States
(12) Patent Application Publication
(10) Pub. No.: US 2024/0281920 A1
(43) Pub. Date: Aug. 22, 2024

(54) INFORMATION PROCESSING APPARATUS AND STORAGE MEDIUM

(71) Applicant: CANON KABUSHIKI KAISHA, Tokyo (JP)

(72) Inventor: KOJI ITO, Tokyo (JP)

(21) Appl. No.: 18/582,238

(22) Filed: Feb. 20, 2024

(30) Foreign Application Priority Data
Feb. 22, 2023 (JP) 2023-025857

(51) Int. Cl. G06T 3/40; G06F 40/166

(52) U.S. Cl. CPC G06T 3/40; G06F 40/166

(57) ABSTRACT

A non-transitory computer-readable storage medium stores a program for causing a computer of an information processing apparatus to execute reducing a size of content including a first object having a predetermined threshold being a lower limit value of size and a second object different from the first object, and placing the first object so that the first object does not overlap the second object in a case where the first object having reached the predetermined threshold and the second object overlap each other by execution of the reducing.

### BACKGROUND

### Field of the Disclosure

The present disclosure relates to an information processing apparatus and a storage medium.

### Description of the Related Art

Conventional application programs for editing content, such as a document, have been known, and technologies for placing a two-dimensional barcode, such as a QR Code® (QR code is a registered trademark of DENSO WAVE CO., LTD.), in a document have been known. In a case were a document including a two-dimensional barcode is edited to reduce a sheet size of the document, the two-dimensional barcode is sometimes reduced to an unreadable size. To address this issue, Japanese Patent No. 4591372 discusses a technology for converting a two-dimensional barcode into text information and placing the text information in a blank space of a document in the case where the two-dimensional barcode may be reduced to an unreadable size.

However, with the technology discussed in Japanese Patent No. 4591372, usability may decrease for a user who wants to use the two-dimensional barcode.

Thus, there are demands for improved usability of a content editing application for users.

### SUMMARY

According to an aspect of the present disclosure, a non-transitory computer-readable storage medium stores a program for causing a computer of an information processing apparatus to execute reducing a size of content including a first object having a predetermined threshold being a lower limit value of size and a second object different from the first object, and placing the first object so that the first object does not overlap the second object in a case where the first object having reached the predetermined threshold and the second object overlap each other by execution of the reducing.

Further features of the present disclosure will become apparent from the following description of exemplary embodiments with reference to the attached drawings.

### BRIEF DESCRIPTION OF THE DRAWINGS

FIG. 1 is a diagram illustrating a configuration of an information processing apparatus.

FIG. 2 is a block diagram illustrating a configuration of a printing device.

FIG. 3 is a diagram illustrating user interface (UI) components of a document editing application.

FIG. 4 is a diagram illustrating a configuration of the document editing application.

FIG. 5 is a flowchart illustrating processing performed by the document editing application.

FIG. 6, including FIGS. 6A and 6B, is a flowchart illustrating sheet size change processing.

FIG. 7 is a flowchart illustrating QR Code® display adjustment processing.

FIG. 8 is a flowchart illustrating movement necessity determination processing.

FIG. 9 is a flowchart illustrating movement necessity determination processing (auto).

FIG. 10 is a flowchart illustrating movement necessity determination processing (custom).

FIGS. 11A and 11B are diagrams illustrating a movement of a QR Code® position.

FIG. 12 is a diagram illustrating adjustment processing for different object types and states.

FIG. 13 is a diagram illustrating a sheet size selection screen.

FIG. 14 is a diagram illustrating text adjustment processing.

FIG. 15 is a diagram illustrating text adjustment processing in a case where there is an object immediately below.

FIG. 16 is a diagram illustrating adjustment processing of adjusting a shape in contact with a sheet edge.

FIG. 17 is a diagram illustrating image adjustment processing.

FIG. 18 is a diagram illustrating image trimming change processing.

FIG. 19 is a diagram illustrating image trimming change processing in a case where there is an object immediately below.

FIG. 20 is a diagram illustrating a QR Code® overlay placement permission setting dialog.

FIG. 21 is a diagram illustrating an error message.

### DESCRIPTION OF THE EMBODIMENTS

The present disclosure will be described in detail below with reference to the drawings. It should be noted that exemplary embodiments described below are not intended to limit the claimed disclosure and that not all combinations of features according to the exemplary embodiments are always essential to a technical solution provided by the present disclosure. Further, components that are identical or similar to each other are given the same reference numeral in the attached drawings, and redundant descriptions thereof are omitted.

A document to be edited by a document editing application according to the present disclosure can be an ordinary office document or can be content for a specific use, such as a poster, a postcard, or presentation data. Further, template data stored in advance in the document editing application is sometimes referred to as a document, or template data to which an object is added and edited by a user is sometimes referred to as a document. Further, the document editing application has various functions for editing documents and can perform resizing processing, moving processing, and rotating processing on objects in the documents and trimming processing on images in the documents. Various information processing apparatuses, such as a personal computer, a smartphone, a mobile terminal, a tablet terminal, and a personal digital assistant (PDA), are applicable as an information processing apparatus according to an exemplary embodiment of the present disclosure.

### <System Configuration>

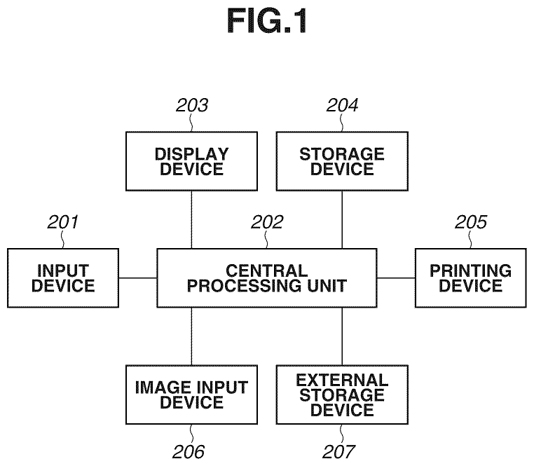

FIG. 1 is a diagram illustrating a configuration of an information processing apparatus on which a document editing application 1102 according to an exemplary embodiment of the present disclosure runs. In FIG. 1, a component 201 is an input device, such as a keyboard and a mouse, a component 202 is a central processing unit (CPU), and a component 203 is a display device, such as a liquid crystal monitor. The CPU 202 performs system management/control and document editing processing, and the display device 203 displays a screen representing the document editing application 1102. Further, a component 204 is a storage device, such as a hard disk, in which a file system is constructed, and actual content of the application, document templates, fonts, and decorative data are stored on the file system. A component 205 is a printing device configured to print documents. According to the present exemplary embodiment, in a case where a print instruction to print a document generated by the document editing application 1102 is acquired, the printing device 205 performs printing of the generated document. Further, a component 206 is an image input device, such as a film scanner, a flatbed scanner, or a digital camera, and a component 207 is an external storage device that supports media for use in digital cameras. Image data on the external storage device 207 can be imported as an object into a document. The document editing application 1102 can be a web application that is supplied from a web application server and is executed on a web browser.

### <Configuration of Printing Device>

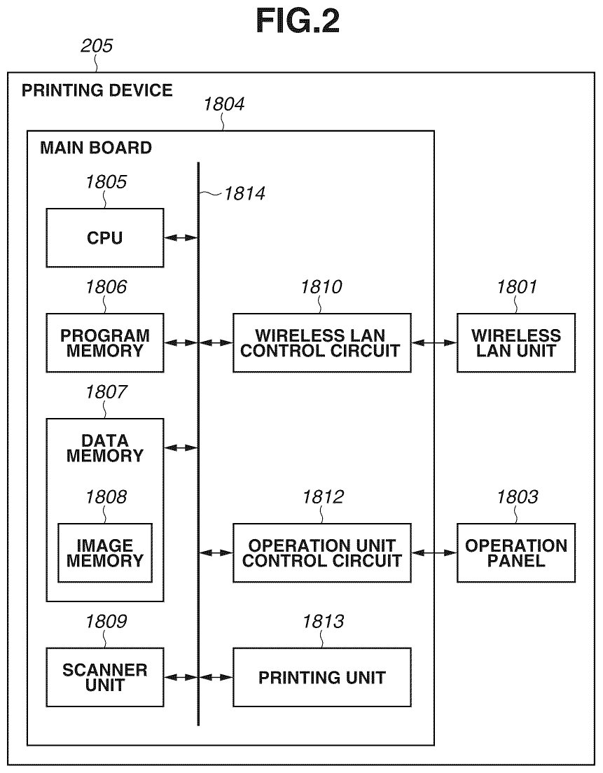

FIG. 2 is a block diagram illustrating a configuration of the printing device 205. The printing device 205 includes a main board 1804, a wireless local area network (wireless LAN) unit 1801, and an operation panel 1803. The main board 1804 controls the entire device. The wireless LAN unit 1801 functions as a communication unit of the printing device 205.

A CPU 1805 in the form of a microprocessor is placed on the main board 1804. The CPU 1805 runs based on control programs stored in a program memory 1806 in the form of a read-only memory (ROM) and content of a data memory 1807 in the form of a random access memory (RAM). The program memory 1806 and the data memory 1807 are connected to the CPU 1805 via an internal bus 1814.

The CPU 1805 controls a scanner unit 1809, reads a document, and stores the read document in an image memory 1808 in the data memory 1807. Further, the CPU 1805 controls a printing unit 1813 and prints an image in the image memory 1808 in the data memory 1807 on a recording medium. Further, the CPU 1805 can transmit scanned image data to the CPU 202 via the wireless LAN unit 1801 controlled by a wireless LAN control circuit 1810.

The CPU 1805 communicates with the CPU 202 using a wireless LAN by controlling the wireless LAN unit 1801 via the wireless LAN control circuit 1810. The CPU 1805 can display a state of the printing device 205 and a function selection menu on the operation panel 1803 and can receive user operations by controlling an operation unit control circuit 1812. The printing device 205 according to the present exemplary embodiment can receive Joint Photographic Experts Group (JPEG) file format data with printer control commands and can print the received data.

### <Application Configuration>

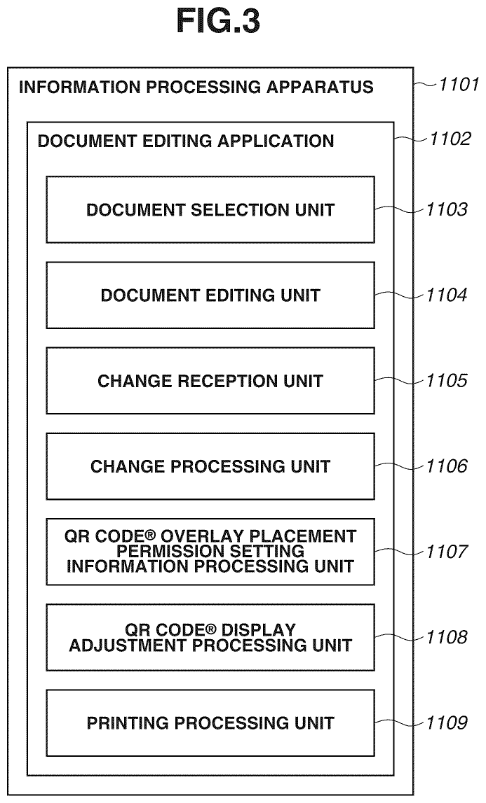

FIG. 3 is a diagram illustrating a configuration of the document editing application 1102 running on an information processing apparatus 1101. A component 1103 is a document selection unit for selecting a document to be edited. A component 1104 is a document editing unit for displaying and editing the document selected by the document selection unit 1103. A component 1105 is a change reception unit for receiving a change in sheet size of the document being edited by the document editing unit 1104. A component 1106 is a change processing unit for changing the sheet size of the document based on a sheet size a change to which has been received by the change reception unit 1105. A component 1107 is a QR Code® overlay placement permission setting information processing unit configured to control a setting of permitting placement of a QR Code® on (top of) an object. A component 1108 is a QR Code® display adjustment processing unit configured to perform QR Code® display adjustment processing after sheet size change processing. A component 1109 is a printing processing unit for executing a print instruction for causing the printing device 205 to print a document. The component 1109 is a printing processing unit for printing a document.

### <Document Editing Application UI Configuration>

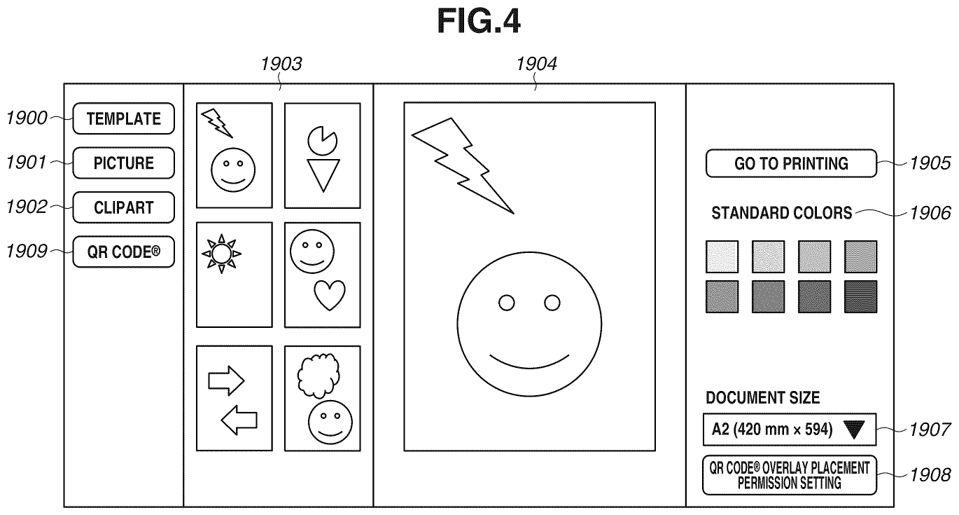

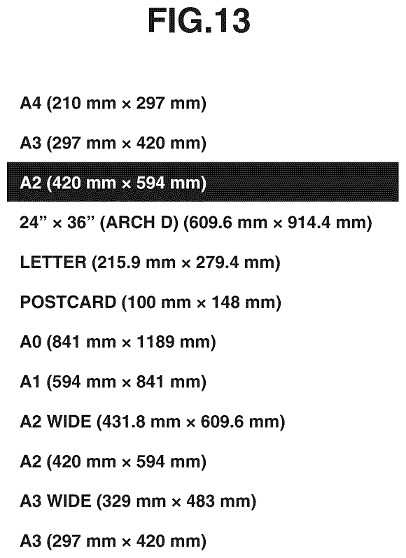

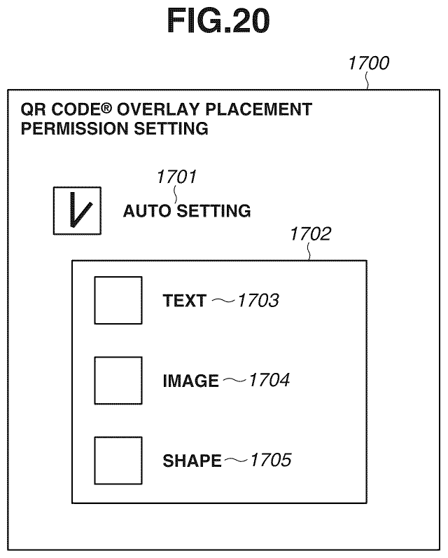

FIG. 4 is a diagram illustrating a screen of the document editing application 1102. At a press of one of a template button 1900, a picture button 1901, a clipart button 1902, and a QR Code® button 1909, a list of contents corresponding to the pressed button is displayed in a list display area 1903. For example, in a case where the template button 1900 is pressed, a list of selectable templates is displayed in the list display area 1903. In a case where a desired template is selected from the list displayed in the list display area 1903, the selected template is displayed in an editing area 1904 and changed to an editable state. In a case where the picture button 1901 is pressed, a list of selectable images is displayed in the list display area 1903, and in a case where a desired image is selected, the selected image is added and overlaid on the template displayed in the editing area 1904. Similarly, in a case where the clipart button 1902 is pressed, a list of selectable clipart images is displayed in the list display area 1903, and in a case where a desired clipart image is selected, the selected clipart image is added and overlaid on the template displayed in the editing area 1904. In a case where the QR Code® button 1909 is pressed, a screen on which text can be input is displayed, and a QR Code® generated based on the input text is added and overlaid on the template displayed in the editing area 1904. The input text may be, for example, a character string such as a universal resource locator (URL) or an email address. The user adds and edits the image and the clipart image on the template in the list display area 1903 and generates a document. While templates and generated documents that are in Scalable Vector Graphics (SVG) image format are described herein, templates and generated documents that are in Canvas format can also be used. In a case where a GO TO PRINTING button 1905 is pressed, a print settings screen (not illustrated) of a printer driver is displayed. A palette region 1906 displays a plurality of regions corresponding to different colors to select a color to be applied to the clipart image, and in a case where a desired color is selected with the clipart image in an activate state in the editing area 1904, the clipart image is changed to the selected color. In a document (sheet) size selection section 1907, a desired sheet size in printing the generated document is selectable. Details thereof will be described below with reference to FIG. 13. In a case where a QR Code® overlay placement permission setting button 1908 is pressed, a QR Code® overlay placement permission setting dialog is displayed. Details thereof will be described below with reference to FIG. 20.

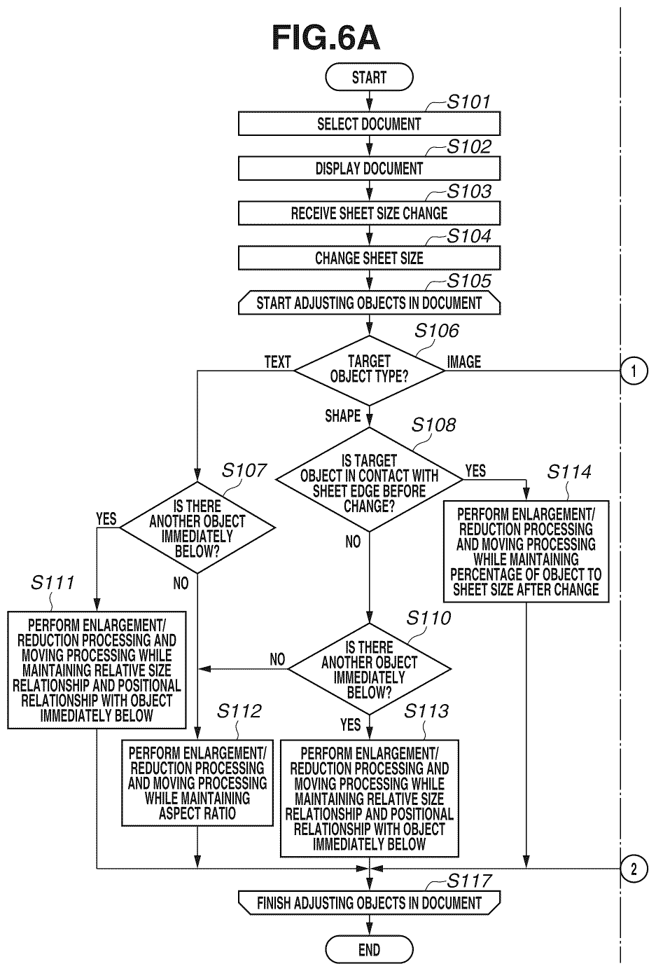

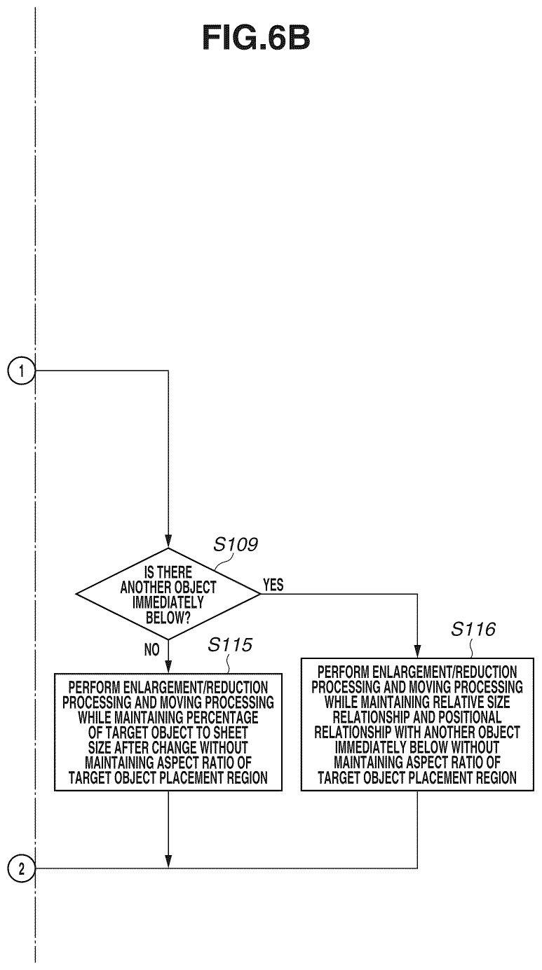

Meanwhile, the document editing application 1102 has a function of performing the sheet size change processing (auto-resizing processing) in a case where a sheet size is changed via the document size selection section 1907. The sheet size change processing is processing of adjusting sizes and positions of objects in a document to appropriate sizes and appropriate positions based on the selected sheet size in changing the sheet size of the document displayed in the editing area 1904. Details of the sheet size change processing will be described below with reference to FIG. 6.

A case where, for example, an object with a size adjusted as a result of the sheet size change processing is a two-dimensional barcode (hereinafter, referred to as a “QR Code®”) will be described below.

The QR Code® is read by a reader device having a QR Code® reading function, and the reader device acquires information contained in the QR Code®, decodes the acquired information, and analyzes the decoded information. However, in a case where the QR Code® is smaller in size than a predetermined threshold, the reader device may not be able to read the QR Code®. In this case, the information contained in the QR Code® may not be acquired by the reader device. Thus, the predetermined threshold that is a lower limit value of size that can be read by the reader device is set for QR Codes®, and the document editing application 1102 performs control to prevent the QR Code® from being reduced to and displayed at a size smaller than the predetermined threshold. This makes it possible for the reader device to read the QR Code®. The reader device can be, for example, an external information processing apparatus, such as a smartphone or a tablet terminal, or an apparatus having a camera function.

Considering those described above, the following issue may arise. In a case where the sheet size change processing is performed on a document displaying a plurality of objects including a QR Code® and reduction processing is performed to reduce a size of each object, the size of the QR Code® is reduced only to the predetermined threshold. Thus, the QR Code® may be displayed at a relatively larger size than objects other than the QR Code® in the document. This may cause the QR Code® and another object to overlap each other, and an appropriate document may not be generated due to the overlap of the QR Code® and the other object.

There may be a case where a lower limit value in performing the reduction processing is set for an object other than the QR Code®. In this case, the lower limit value for the object other than the QR Code® is to be a value smaller than the lower limit value for the QR Code® according to the present exemplary embodiment.

According to the present exemplary embodiment, in order to solve the above-described issue, the document editing application 1102 changes a position of a QR Code® from a first position determined as a position for placing the QR Code® by the sheet size change processing to a second position where the QR Code® does not overlap another object in a case where the sheet size change processing is performed on a document including a plurality of objects including the QR Code® and the QR Code® having reached the predetermined threshold overlaps the other object. Specifically, in a case where the sheet size change processing is performed, the processing of moving the QR Code® placed in the document to an appropriate position and displaying the QR Code® at the position.

Thus, even in the case where the sheet size change processing is performed on a document on which a plurality of objects including a QR Code® is displayed and the QR Code® overlaps another object and is displayed on top of the other object, the document editing application 1102 can remove the overlap between the QR Code® and the other object, generate an appropriate document, and display the generated document.

An object having a lower limit value of reduced size in the reduction processing according to the present exemplary embodiment is the QR Code® but can be any other object. For example, a configuration may be employed where an object having a lower limit value of reduced size in the reduction processing can be set, and in this case, the object having the lower limit value of reduced size in the reduction processing can be a set object.

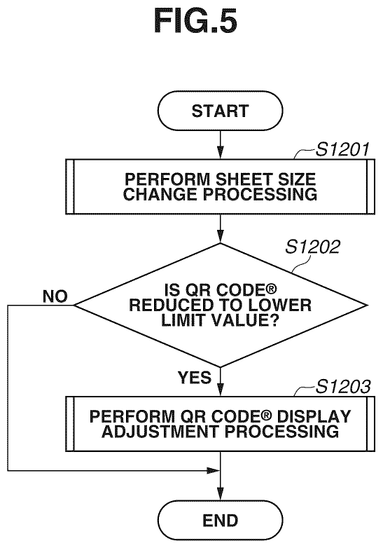

FIG. 5 is a flowchart illustrating processes including the sheet size change processing and the QR Code® display adjustment processing performed by the document editing application 1102. The processes in the flowchart are started based on activation of the document editing application 1102 by the user.

In step S1201, the document editing application 1102 performs the sheet size change processing. Details of the sheet size change processing will be described below with reference to FIG. 6.

In step S1202, the document editing application 1102 determines whether the QR Code® in the document is reduced to the lower limit value by the processing performed in step S1201. In a case where the determination result is YES (YES in step S1202), the processing proceeds to step S1203, whereas in a case where the determination result is NO (NO in step S1202), the process in the flowchart is ended. In a case where the document contains no QR Code®, the determination result is NO in step S1202.

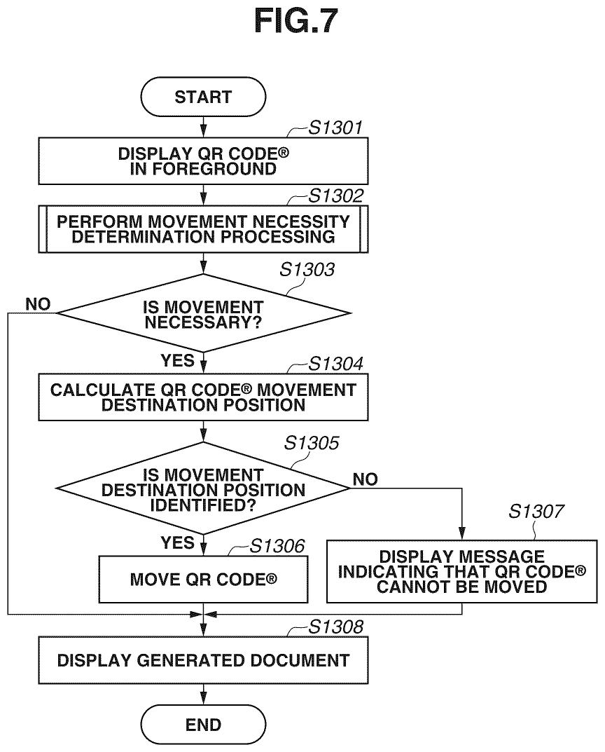

In step S1203, the document editing application 1102 performs the QR Code® display adjustment processing, and the process in the flowchart is ended. Details of the QR Code® display adjustment processing will be described below with reference to FIG. 7.

### <Sheet Size Change Processing>

FIG. 6, including FIGS. 6A and 6B, is a flowchart illustrating processes for the sheet size change processing performed by the information processing apparatus.

In step S101, the document selection unit 1103 selects an editing target document. Various documents for different uses are stored in advance as templates in the storage device 204. For example, the document editing unit 1104 displays a list of document templates corresponding to the templates stored in the storage device 204 on the display device 203 and receives selection of a document by the user. The user selects a document (editing target document) the user wants to use from the list of document templates displayed on the display device 203 via the input device 201. A document can be selected from among the documents prepared in advance as templates as described above or can be selected from among documents generated by the user in the past. The document editing application 1102 according to the present exemplary embodiment has the configuration illustrated in FIG. 3 described above.

In step S102, the document editing unit 1104 displays, on the display device 203, the document selected by the user in step S101 from among the documents stored in the storage device 204. The document displayed on the display device 203 is in an editable state via the input device 201.

In step S103, the change reception unit 1105 receives a change in sheet size of the document displayed in step S102. The change reception unit 1105 displays, for example, a list of sheet sizes as illustrated in FIG. 13 on the display device 203 and receives a change in sheet size (selection) from the user. The user selects a sheet size to use (sheet size after the change) from the list of sheet sizes displayed on the display device 203 via the input device 201. In a case where the document (document template) displayed in step S102 is generated in “A2” sheet size, the list of sheet sizes is displayed with “A2” being selected as a default sheet size as illustrated in FIG. 13. Then, as the user selects the sheet size to use, the change reception unit 1105 receives the change in sheet size of the document displayed in step S102. An example of a case where the sheet size of a document is changed is a case where a document to be printed by the printing device 205 is different in sheet size from the document (document template) displayed in step S102. Further, the receiving of the change in sheet size is not limited to the form illustrated in FIG. 13. For example, instead of displaying the list of sheet sizes and prompting the user to select a sheet size, it is possible to prompt the user to select whether to place the sheet in landscape orientation or portrait orientation or to set an intended sheet size using numerical values.

In step S104, the change processing unit 1106 changes the sheet size of the document displayed in step S102 based on the sheet size (changed sheet size) received in step S103.

In the present exemplary embodiment, the change processing unit 1106 functions as an adjustment unit that performs adjustment processing to adjust sizes and positions of objects in a document based on information about the objects so as to be suitable for the sheet size of the document after the change as in steps S105 to S117. The information about the objects in the document herein includes at least one of information about types of the objects, information about details of the objects, and information about placement states of the objects in the document. The change processing unit 1106 repeatedly performs processing in steps S106 to S116 as a routine as illustrated in steps S105 and S117 on each object in the document as an adjustment processing target object until all the objects in the document are processed. As described above, in the present exemplary embodiment, a document layout is adjusted automatically based on a change in sheet size of the document so that the user does not have to adjust each object in the document manually.

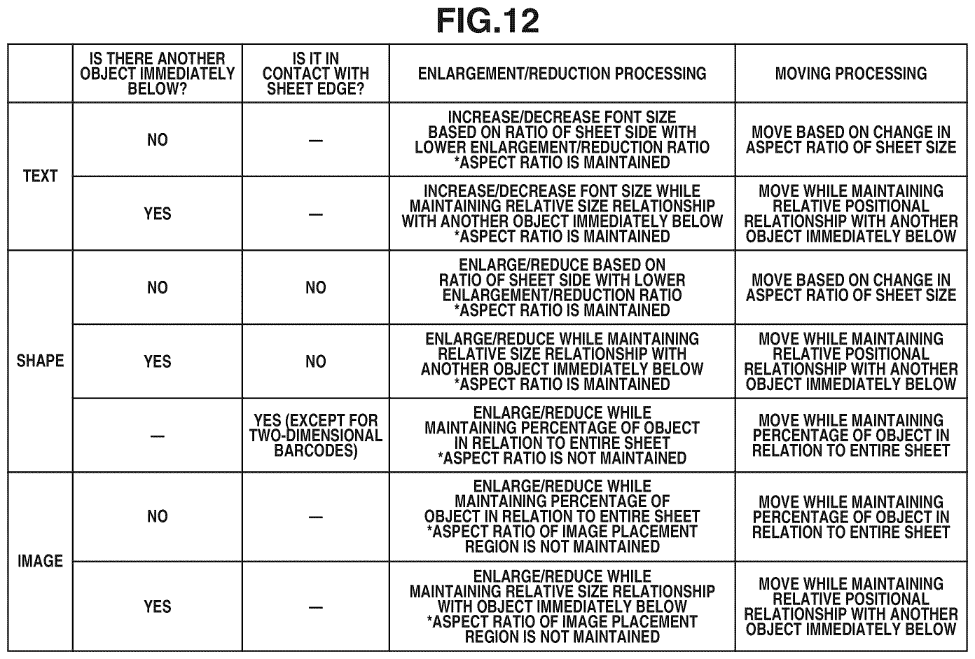

Details of steps S106 to S116 in the sheet size change processing in FIG. 6 will be described below with reference to FIG. 12. FIG. 12 is a diagram illustrating an example of the adjustment processing based on information about objects in a document, i.e., types, details, and placement states of the objects. In changing the sheet size of a document, the change processing unit 1106 adjusts sizes and positions of objects in the document as illustrated in FIG. 12. A case where there are three types of objects in a document that are “text”, “shape”, and “image” will be described below as an example.

In step S106, the change processing unit 1106 determines whether a type of single object that is a target object in the document is “text”, “shape”, or “image” (the type of target object is determined). According to the present exemplary embodiment, the “shape” includes not only squares and circles but also clipart images including a pictorial pattern and two-dimensional barcodes such as a QR Code®. In a case where the type of target object is “text” (TEXT in step S106), the processing proceeds to step S107. In a case where the type of target object is “shape” (SHAPE in step S106), the processing proceeds to step S108. In a case where the type of target object is “image” (IMAGE in step S106), the processing proceeds to step S109.

In step S107, the change processing unit 1106 determines whether there is another object immediately below the target object (“text”). In the present exemplary embodiment, in a case where the type of target object is “text”, a step to which the processing proceeds depends on whether there is another object immediately below the target object. Whether there is another object is determined based on region information about the target object “text” and region information about an object in a lower layer below the “text”. Specifically, in a case where an object with a region that completely encompasses a region of the “text” is in the lower layer, the change processing unit 1106 determines that there is another object immediately below the target object, and the processing proceeds to step S111. On the other hand, in a case where there is no object with a region that completely encompasses a region of the “text” in the lower layer, the change processing unit 1106 determines that there is no object immediately below the target object, and the processing proceeds to step S112.

In step S112, the change processing unit 1106 performs enlargement/reduction processing and moving processing on the “text” based on the sheet size of the document after the change while maintaining an aspect ratio of the target object “text”.

In the enlargement/reduction processing on the “text”, a font size of the target object “text” is increased/decreased based on a scaling factor of a sheet side with a lower enlargement/reduction ratio. For example, in a case of changing a sheet size with a length of 100 cm and a width of 50 cm to a sheet size with a length of 50 cm and a width of 30 cm, the font size of the “text” is decreased to ½ (=50 cm/100 cm) based on the scaling factor of the side with the lower enlargement/reduction ratio. In this case, while the font size of the “text” is changed, an aspect ratio of the font is unchanged (maintained). This is because changing the aspect ratio of the font in a case where an amount of change in sheet size is large causes distortion of the font, and this often changes the impression of the design of the “text” from that before the sheet size is changed.

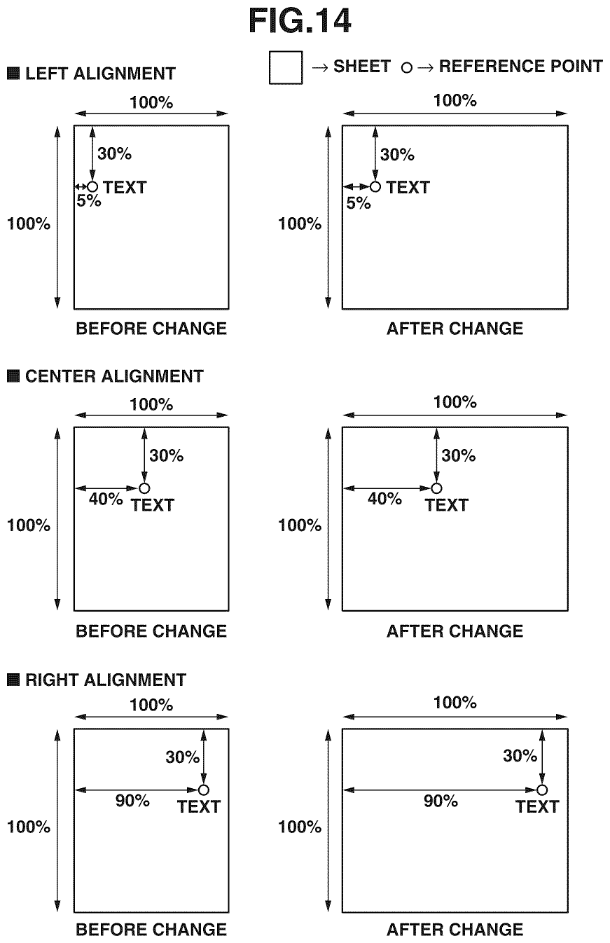

In the moving processing on the “text”, the position of the target object “text” is moved based on a change in aspect ratio of the sheet of the document. For example, as illustrated in FIG. 14, the position of the “text” is moved so that percentages of the position of a reference point of the “text” remain the same before and after a sheet size change. As illustrated in FIG. 14, the reference point (the position of the reference point) in moving the “text” is changed based on a “text” alignment setting (left alignment, center alignment, right alignment). In a case where the “text” alignment setting is the left alignment, the reference point is the left center of the “text”. In a case where the “text” alignment setting is the center alignment, the reference point is the center of the “text”. In a case where the “text” alignment setting is the right alignment, the reference point is the right center of the “text”. Further, in a case where the “text” is in vertical writing, the reference point is the top center, the center, or the bottom center of the “text” depending on the alignment setting. Thus, in a case where, for example, the sheet size of a document in which a plurality of pieces of left-aligned “text” is vertically placed with their left edges aligned is changed, each piece of “text” can be moved while the position of the left edge is aligned by changing the reference point in moving the “text” as described above. This prevents distortion of the “text” layout.

In step S111, the change processing unit 1106 performs the enlargement/reduction processing and the moving processing on “text” while maintaining the relative size relationship and the positional relationship between the target object “text” and the other object immediately below the target object “text”.

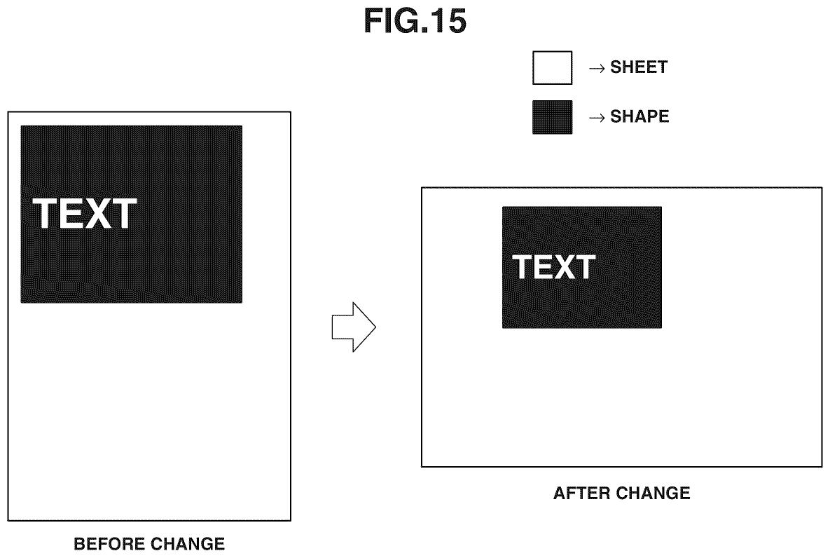

A case where, for example, a “shape” (black) is in an upper portion of a document and “text” is in a left portion on the “shape” as illustrated in FIG. 15 will be considered. In this case, in the document after the sheet size change, the font of the “text” is reduced based on a reduction of the “shape”, and the “text” is placed at a position on the left on the “shape”. In FIG. 15, since the “text” is left-aligned, the reference point is the left center of the “text”, and the positional relationship between the “shape” and the reference point of the “text” is maintained.

By performing the enlargement/reduction processing and the moving processing based on the other object positioned immediately below the target object “text” as described above, an imbalance of their positional relationship (placement relationship) is prevented.

In step S108, the change processing unit 1106 determines whether the target object “shape” is in contact with a sheet edge before the sheet size change. Whether the “shape” is in contact with the sheet edge before the sheet size change is determined by defining a rectangle surrounding the “shape” and determining whether at least two vertices of the rectangle are on the sheet edge. Specifically, whether the “shape” is in contact with the sheet edge before the sheet size change is determined based on coordinate values of the vertices of the rectangle surrounding the “shape” and coordinate values of the sheet edge.

However, there may be a case where the target object “shape” is not completely in contact with the sheet edge (without displacement). Thus, a tolerance range (margin) from the sheet edge can be set, and whether the “shape” is in contact with the sheet edge before the sheet size change can be determined. In a case where the “shape” is not in contact with the sheet edge before the sheet size change (NO in step S108), the processing proceeds to step S110. On the other hand, in a case where the “shape” is in contact with the sheet edge before the sheet size change (YES in step S108), the processing proceeds to step S114.

In step S110, as in step S107, the change processing unit 1106 determines whether there is another object immediately below the target object (“shape”). In a case where there is no other object immediately below the target object (“shape”) (NO in step S110), the processing proceeds to step S112. On the other hand, in a case where there is another object immediately below the target object (“shape”) (YES in step S110), the processing proceeds to step S113.

In the case where the target object is “shape”, unless the “shape” is in contact with the sheet edge before the sheet size change, subsequent steps S112 and S113 are basically similar to those in the case where the target object is “text”. Thus, in step S112, the change processing unit 1106 performs the enlargement/reduction processing and the moving processing on the target object “shape” while maintaining an aspect ratio of the target object “shape” based on the sheet size of the document after the change. It should be noted that, in the moving processing on the “shape”, the reference point (the position of the reference point) in moving the “shape” is always the center of the “shape”. In the case where the target object is “shape”, as in the case where the target object is “text”, the aspect ratio of the “shape” is maintained to prevent distortion of a pictorial pattern of a clipart image or a two-dimensional barcode. Further, in step S113, the change processing unit 1106 performs the enlargement/reduction processing and the moving processing on the target object “shape” while maintaining the relative size relationship and the positional relationship between the target object “shape” and the other object immediately below the target object “shape”.

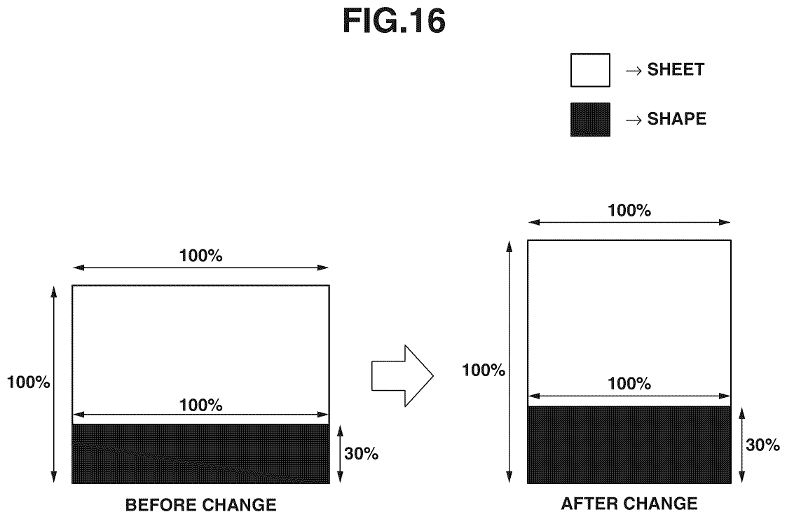

In step S114, the change processing unit 1106 performs the enlargement/reduction processing and the moving processing on the “shape” while maintaining the percentage of the “shape” to the sheet size after the change without maintaining the aspect ratio of the target object “shape”. This is because blank spaces become noticeable in a case where the “shape” (except for two-dimensional barcodes) is in contact with the sheet edge unless the “shape” is enlarged/reduced based on the aspect ratio of the sheet size after the change. Specifically, as illustrated in FIG. 16, the “shape” (black) in contact with the sheet edge is enlarged/reduced so that the ratio between the length and the width of the “shape” is maintained before and after the sheet size change. At this time, the “shape” is enlarged/reduced without maintaining the aspect ratio of the “shape”. In moving the “shape”, the “shape” is placed so as to be in contact with the sheet edge while the percentage of the “shape” to the entire sheet is maintained.

In steps S113 and S114, in a case where the target object is a QR Code® and the enlargement/reduction processing is performed, the QR Code® is reduced to the predetermined threshold that is the lower limit value of size that can be read by the reader device.

In step S109, as in steps S107 and S110, the change processing unit 1106 determines whether there is another object immediately below the target object (“image”). In a case where there is no other object immediately below the target object (“image”) (NO in step S109), the processing proceeds to step S115. On the other hand, in a case where there is another object immediately below the target object (“image”) (YES in step S109), the processing proceeds to step S116.

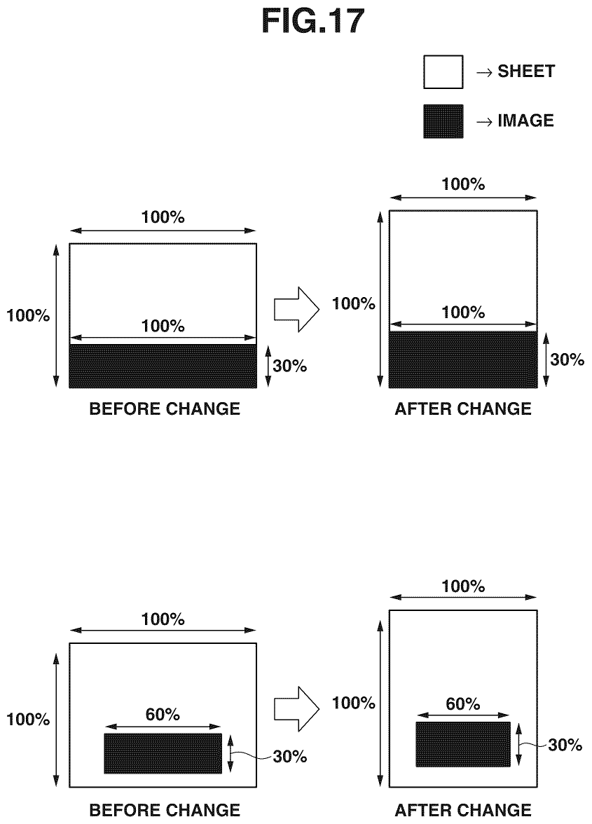

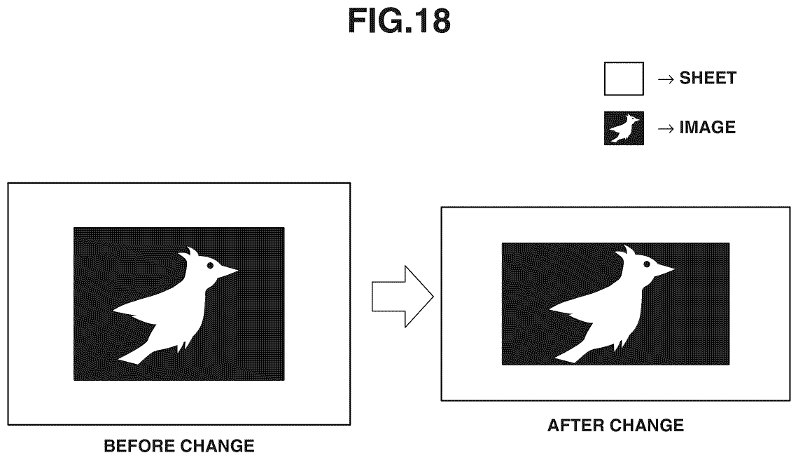

In step S115, the change processing unit 1106 performs the enlargement/reduction processing and the moving processing on the “image” while maintaining the percentage of the target object “image” to the entire sheet as illustrated in FIG. 17. At this time, the “image” is enlarged/reduced without maintaining an aspect ratio of a placement region of the “image”. It should be noted that, in order to prevent distortion of the “image”, a trimming region of the “image” is changed based on the aspect ratio of the placement region of the “image” after the sheet size change. Specifically, as illustrated in FIG. 18, in a case where the placement region of the “image” after the sheet size change is landscape-oriented, the trimming region of the “image” is also changed to the same aspect ratio as the placement region of the “image”. Similarly, in a case where the placement region of the “image” after the sheet size change is portrait-oriented, the “image” is trimmed to be portrait-oriented.

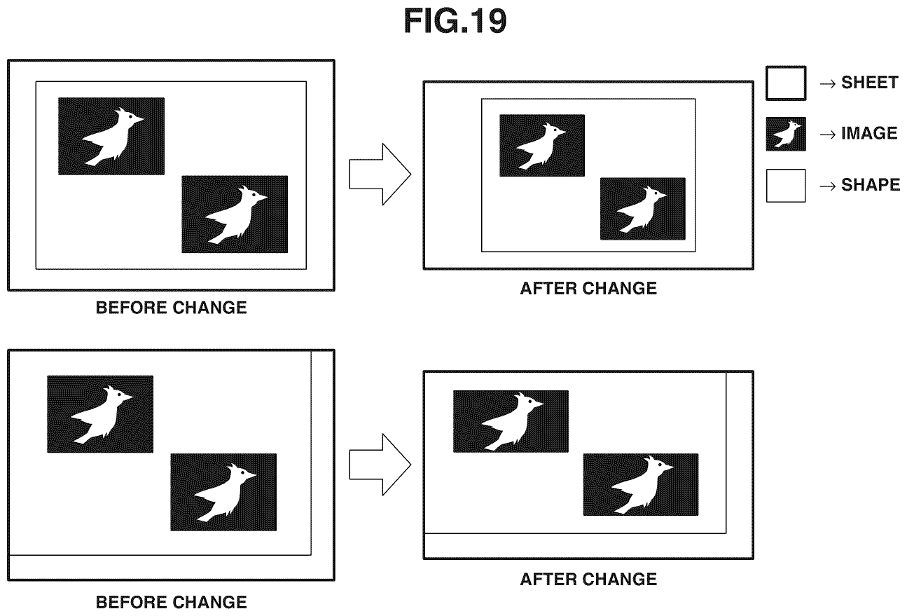

In step S116, the change processing unit 1106 performs the enlargement/reduction processing and the moving processing on the target object “image” while maintaining the relative size relationship and the positional relationship between the target object “image” and the other object immediately below the target object “image”. A case where, for example, there is another object “shape” immediately below an “image” as illustrated in FIG. 19 will be considered. In this case, unless an aspect ratio of the “shape” is changed, an aspect ratio of the “image” (the placement region of the “image”) is unchanged. However, in a case where the aspect ratio of the “shape” is changed, the aspect ratio of the “image” is changed based on the aspect ratio of the “shape” after the change.

As described above, in the present exemplary embodiment, whether to maintain an aspect ratio in changing the sheet size of a document is determined for each object in the document based on a type of object, details of the object, and a placement state of the object in changing the sheet size of the document. The determination is performed by the change processing unit 1106 as described above (steps S106 to S110).

Then, the change processing unit 1106 adjusts a size and a position of each object determined as an object to be maintained its aspect ratio among objects in the document while maintaining the aspect ratio of the object. In other words, in adjusting the aspect ratio of the document based on the sheet size of the document after the change, the sizes and positions of the objects in the document are adjusted based on the types, details, and the placement states of the objects. This makes it possible to prevent distortion of each object determined as the object to be maintained its aspect ratio among the objects in the document. Specifically, distortion of a pictorial pattern of a clipart image or a two-dimensional barcode in the document is prevented.

In the present exemplary embodiment, while the cases of maintaining the aspect ratio of a “text” or “shape”, which is an object in the document, are described above, the cases are not limiting cases. For example, a tolerance range can be set for the (rate of change in) aspect ratio of the “text” or “shape” in the document to allow some distortions. In this case, the size of the “text” or “shape” is adjusted to maintain the aspect ratio within the preset tolerance range. For example, the aspect ratio of the “text” or “shape” is adjusted until the preset tolerance range is exceeded, and once the preset tolerance range is exceeded, the aspect ratio of the “text” or “shape” is not adjusted any further.

In the present exemplary embodiment, while the cases of moving the “text” or “shape” in the document based on the aspect ratio of the sheet size of the document are described above, a tolerance range can be set for a movement range. In this case, the “text” or “shape” in the document is moved until the preset movement range is exceeded, and once the preset movement range is exceeded, the “text” or “shape” is not moved any further.

Further, a plurality of candidate documents (layouts) generated using different conditions of the presence or absence of aspect ratio adjustment, the tolerance range (the rate of change in aspect ratio), and the movement range described above can be displayed, and the user can select a desired document (layout) from the plurality of candidate documents. For example, the change processing unit 1106 adjusts the sizes of the objects in the document using each of a plurality of aspect ratios different from each other and generates a plurality of candidate documents including the objects corresponding to the plurality of aspect ratios. The plurality of candidate documents generated as described above is displayed on the display device 203, and the user selects a single candidate document as the document after the sheet size change from the plurality of candidate documents displayed on the display device 203 via the input device 201.

In the present exemplary embodiment, while the cases of adjusting a size and a position of a “shape” in a document without maintaining an aspect ratio of the “shape” in a case where the target object is “shape” and the “shape” is in contact with the sheet edge are described above as examples, the cases are not limiting cases. For example, whether to maintain the aspect ratio of the “shape” can be determined based on details of the “shape”. Specifically, in a case where the “shape” (details of the “shape”) is an object painted in a solid color or an object such as a table, some distortions in the “shape” are considered to be allowable, so that the aspect ratio of the “shape” does not have to be maintained. Further, whether to maintain the aspect ratio of the “shape” can be determined based on the percentage (placement state in the document) of the target object “shape” in contact with the sheet edge, or methods for the enlargement/reduction processing and the moving processing can be changed. The percentage of the “shape” in contact with the sheet edge includes, for example, the number of sides of the “shape” in contact with the sheet edge in addition to the number of vertices of the “shape” in contact with the sheet edge. For example, the aspect ratio of the “shape” can be maintained in a case where the “shape” is hardly in contact with the sheet edge, or the aspect ratio of the “shape” does not have to be maintained in a case where two or more sides of the “shape” are in contact with the sheet edge.

In the present exemplary embodiment, while the cases of maintaining the aspect ratio of the target object “text” regardless of details of the “text” are described above, whether to maintain the aspect ratio of the “text” can be determined based on wording or font type of the “text”. For example, in a case where the “text” consists of alphanumeric characters only or in a case where distortion of the font of the “text” has little effect on design, adjustment of the aspect ratio of the “text” can be allowed.

In the present exemplary embodiment, while the case in which the document editing application 1102 (the change processing unit 1106) automatically determines whether to maintain the aspect ratio of each object in the document is described above, the case is not a limiting case. For example, the user can set an object the aspect ratio of which is to be maintained among objects in the document. Specifically, a setting unit that sets a condition related to an object the aspect ratio of which is to be maintained in changing a sheet size of a document based on a user setting (input) is provided. Then, whether to maintain the aspect ratio in changing the sheet size of the document is determined for each object in the document based on the condition set by the setting unit.

### <QR Code® Display Adjustment Processing>

Next, the QR Code® display adjustment processing performed in step S1203 in FIG. 5 will be described with reference to FIG. 7.

In step S1301, the QR Code® display adjustment processing unit 1108 performs processing of displaying a QR Code® contained in the document in the foreground. The processing is for displaying the QR Code® in the foreground with priority because the reader device cannot read the QR Code® if a part of the QR Code® is missing.

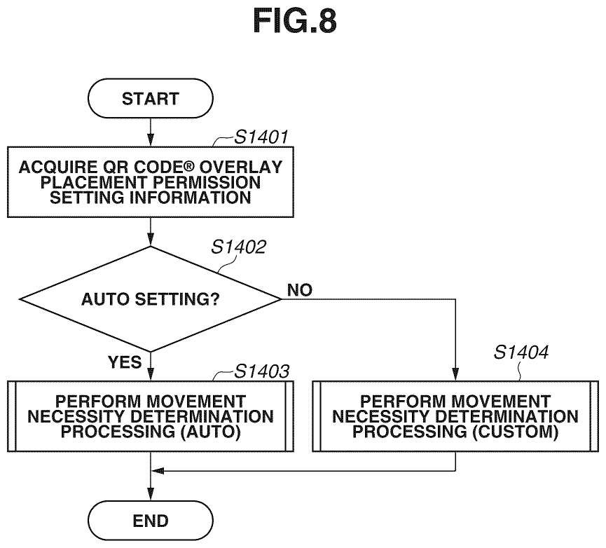

In step S1302, the QR Code® display adjustment processing unit 1108 performs movement necessity determination processing on an object that overlaps the QR Code® in the document to determine whether it is necessary to move the QR Code®. Details of the movement necessity determination processing will be described below with reference to FIG. 8.

In step S1303, the QR Code® display adjustment processing unit 1108 determines whether it is necessary to move the QR Code® based on a result of the movement necessity determination processing in step S1302. Specifically, in a case where a QR Code® movement flag is turned on in the movement necessity determination processing in step S1302, the QR Code® display adjustment processing unit 1108 determines that it is necessary to move the QR Code®.

In a case where a determination result in step S1303 is YES (YES in step S1303), the processing proceeds to step S1304, whereas in a case where the determination result in step S1303 is NO (NO in step S1303), the processing proceeds to step S1308. QR Code® moving processing is processing of moving a QR Code® from a position of the QR Code® that is determined through the sheet size change processing by the document editing application 1102 to a position in a region where the QR Code® does not overlap objects other than the QR Code® in the document.

In step S1304, the QR Code® display adjustment processing unit 1108 calculates a position of the QR Code® (hereinafter, the position will be referred to as a QR Code® movement destination position) in a predetermined region where the QR Code® does not overlap an object other than the QR Code® in the document in a case where the QR Code® in the document is moved, and the QR Code® display adjustment processing unit 1108 identifies the position. Specifically, the QR Code® display adjustment processing unit 1108 determines whether there is a region where an object other than the QR Code® in the document is not placed and that has a size greater than (or greater than or equal to) a region having a size corresponding to a lower limit size of the QR Code® (a region with vertical sides each having a length corresponding to a lower limit length and horizontal sides each having a length corresponding to a lower limit length). In a case where the QR Code® display adjustment processing unit 1108 determines that there is such a region, coordinates of a position in the region are identified. For example, coordinates of an intersection of the left side and the upper side of the QR Code® so that the QR Code® fits within the region are identified. In a case where there is a plurality of predetermined regions, a position having coordinates closer to coordinates of a position determined through the sheet size change processing is identified as a QR Code® movement destination position. This is not a limiting case, and a position of a region having a wider region can be identified as a QR Code® movement destination position.

In step S1305, the QR Code® display adjustment processing unit 1108 determines whether a QR Code® movement destination position in the document is identified based on a calculation result in step S1304. In a case where a determination result in step S1305 is YES (YES in step S1305), the processing proceeds to step S1306, whereas in a case where the determination result in step S1305 is NO (NO in step S1305), the processing proceeds to step S1307.

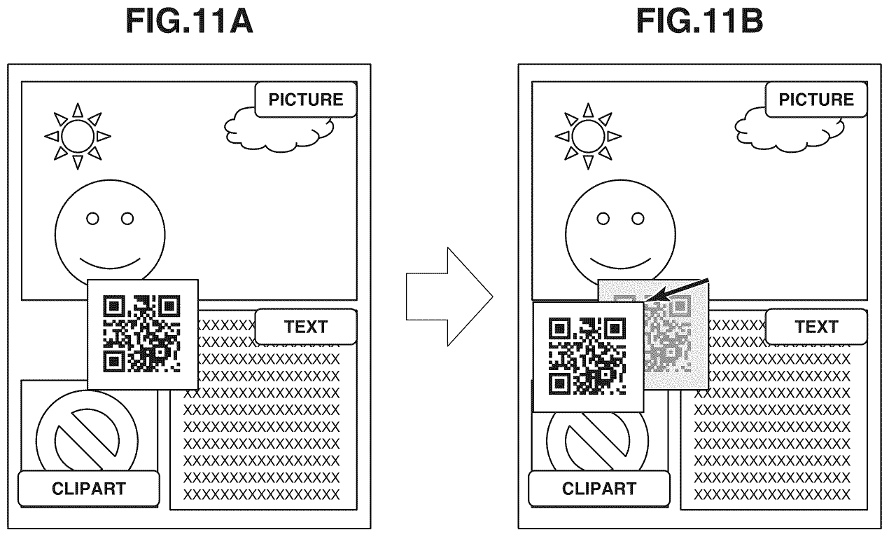

In step S1306, the QR Code® display adjustment processing unit 1108 moves the QR Code® in the document from the position of the QR Code® that is determined through the sheet size change processing to the movement destination position identified in step S1304. For example, the position of the QR Code® is moved as illustrated in FIGS. 11A and 11B. FIGS. 11A and 11B are diagrams illustrating a movement of a QR Code® position. FIG. 11A is a diagram illustrating the QR Code® overlaying other objects, and FIG. 11B is a diagram illustrating the movement of the QR Code® position so that the QR Code® does not overlap the other objects. In a case where the movement destination position is identified in step S1305 in FIG. 7, in step S1306, the QR Code® display adjustment processing unit 1108 moves the QR Code® in the document to the identified movement destination position so that a document displayed in the editing area 1904 changes to a state illustrated in FIG. 11B.

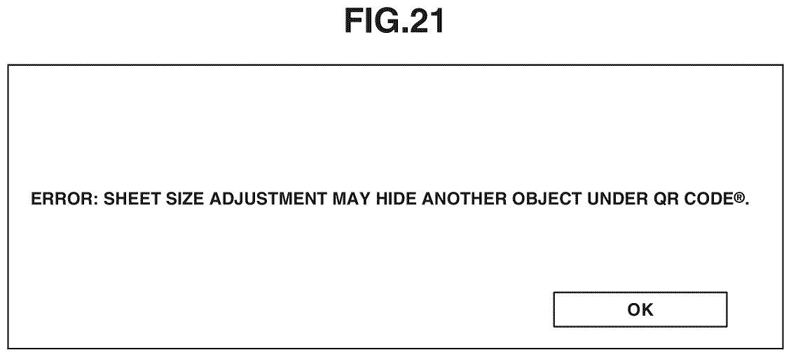

In step S1307, the QR Code® display adjustment processing unit 1108 does not move the QR Code® and displays a screen including an error message indicating that the QR Code® may be placed at an inappropriate position in the document (content with the QR Code® placed at an inappropriate position in the document may be displayed) as illustrated in FIG. 21, and the process in the flowchart is ended. For example, an error message “Sheet size adjustment may hide another object under the QR Code®.” is displayed. Since the user can manually adjust the position of the QR Code® displayed in the editing area 1904, for example, an error message “Sheet size adjustment may hide another object under the QR Code®. Please adjust the position of the QR Code® manually.” can be displayed.

In step S1308, the QR Code® display adjustment processing unit 1108 displays a screen of the document editing application 1102 with the generated document displayed in the editing area 1904 on the display device 203, and the process in the flowchart is ended. Thus, even in a case where the sheet size change processing is performed on a document on which a plurality of objects including a QR Code® is displayed and the QR Code® overlaps another object and is displayed over the other object, the document editing application 1102 can remove the overlap between the QR Code® and the other object, so that an appropriate document is generated and displayed.

### <Movement Necessity Determination Processing>

Next, the movement necessity determination processing performed in step S1302 in FIG. 7 will be described with reference to FIG. 8.

In step S1401, the QR Code® display adjustment processing unit 1108 acquires QR Code® overlay placement permission setting information. The QR Code® overlay placement permission setting information processing unit 1107 manages overlay placement permission setting information, and the QR Code® overlay placement permission setting information is setting information applied to an object other than the QR Code® in the editing area 1904. Specifically, the QR Code® overlay placement permission setting information is setting information indicating whether an object with which a QR Code® in a document overlaps in a case where the sheet size change processing is performed is an object permitted to be displayed with a QR Code® overlaying the object.

FIG. 20 illustrates a QR Code® overlay placement permission setting dialog 1700 including an auto setting checkbox 1701 and a custom setting region 1702. The custom setting region 1702 includes a text object setting checkbox 1703, an image object setting checkbox 1704, and a shape object setting checkbox 1705 as custom settings.

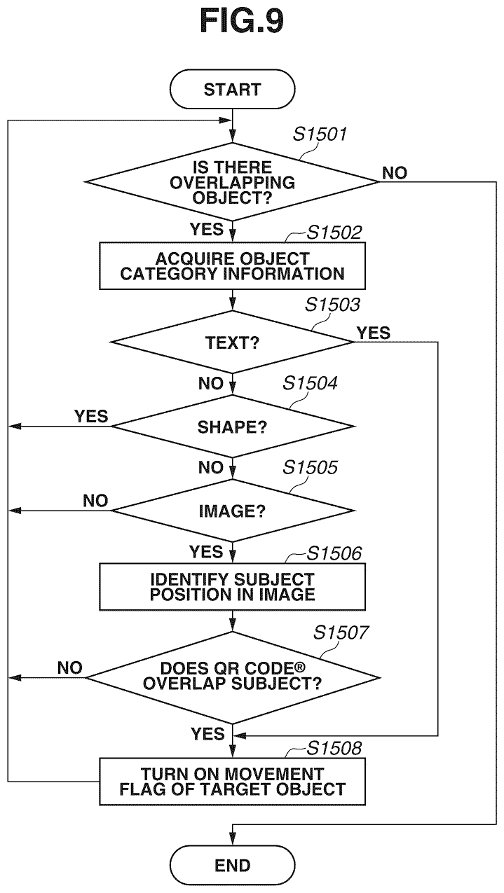

In a state where the auto setting checkbox 1701 is checked (state where movement necessity determination processing (auto) is on), the movement necessity determination processing (auto) described below is applied. In this state, settings of the object setting checkboxes in the custom setting region 1702 are not enabled. Specifically, information indicating whether an object is permitted to be displayed with a QR Code® overlaying the object is automatically set in advance for each object type. Then, in a case where the sheet size change processing is performed and a QR Code® in a document overlaps another object, whether it is necessary to move the QR Code® is determined based on the automatically-set information. In a case where it is determined that it is necessary to move the QR Code®, the QR Code® movement flag is turned on. Details of the automatically-set information will be described below with reference to FIG. 9.

On the other hand, in a state where the auto setting checkbox 1701 is not checked (state where movement necessity determination processing (custom) is on), the movement necessity determination processing (custom) described below is applied, and the settings of the object setting checkboxes in the custom setting region 1702 are enabled. Specifically, the user can set, for objects corresponding to the object setting checkboxes 1703 to 1705 in the custom setting region 1702, whether to permit the object to be displayed with a QR Code® overlaying the object. Then, in a case where the sheet size change processing is performed and a QR Code® in a document overlaps another object, whether it is necessary to move the QR Code® is determined based on the user settings. An object corresponding to an object setting checkbox that is checked in the custom setting region 1702 is an object permitted to be displayed with a QR Code® overlaying the object, so that the QR Code® movement flag is not turned on. On the other hand, an object corresponding to an object setting checkbox that is not checked is an object not permitted to be displayed with a QR Code® overlaying the object, so that the QR Code® movement flag is turned on. For example, in a case where the text object setting checkbox 1703 is checked, a text object is an object permitted to be displayed with a QR Code® overlaying the object, so that the QR Code® movement flag is not turned on. Specifically, a QR Code® is displayed on top of a text object. Further, for example, in a case where the image object setting checkbox 1704 is not checked, an image object is an object not permitted to be displayed with a QR Code® overlaying the object, so that the QR Code® movement flag is turned on.

Specifically, in a case where it is determined that there is a movement destination position in step S1305 in FIG. 7, the QR Code® is displayed without overlaying an image object.

The QR Code® overlay placement permission setting information processing unit 1107 stores the setting information in the QR Code® overlay placement permission setting dialog 1700 in the storage device 204.

Further, at a press of the QR Code® overlay placement permission setting button 1908 for displaying a setting screen of the document editing application 1102, the QR Code® overlay placement permission setting dialog 1700 illustrated in FIG. 20 is displayed on the display device 203.

In step S1402, the QR Code® display adjustment processing unit 1108 determines whether a QR Code® overlay placement permission setting is an auto setting based on the QR Code® overlay placement permission setting information acquired in step S1401. In a case where a determination result in step S1402 is YES (YES in step S1402), the processing proceeds to step S1403 in which the movement necessity determination processing (auto) is performed, whereas in a case where the determination result in step S1402 is NO (NO in step S1402), the processing proceeds to step S1404 in which the movement necessity determination processing (custom) is performed.

In step S1403, the QR Code® display adjustment processing unit 1108 performs the movement necessity determination processing (auto), and the process in the flowchart is ended. The movement necessity determination processing (auto) will be described below with reference to FIG. 9.

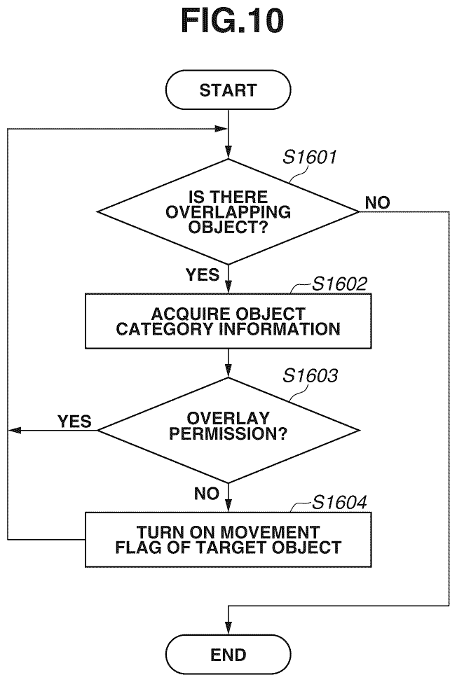

In step S1404, the QR Code® display adjustment processing unit 1108 performs the movement necessity determination processing (custom), and the process in the flowchart is ended. Details of the movement necessity determination processing (custom) will be described below with reference to FIG. 10.

Next, the movement necessity determination processing (auto) performed in step S1403 in FIG. 8 will be described. In the movement necessity determination processing (auto) according to the present exemplary embodiment, whether to move the QR Code® is determined based on importance of visibility of an object indicated by object category information. The object category information is information indicating a type of object overlapping a QR Code®, and in a case where, for example, an object overlapping a QR Code® is a text object, the object category information is text object information. The object category information includes the text object information, shape object information, and image object information.

For example, in a case where the object category information is the text object information, the QR Code® is displayed on top of the text object, so that part of the text may be hidden by the QR Code®. The importance of visibility of the text object is considered to be high because it often becomes difficult for the user to understand content of the text object if a part of the text is missing. Thus, the QR Code® display adjustment processing unit 1108 moves the QR Code® in a case where the object category information is the text object information.

Further, in a case where the object category information is the shape object information, the QR Code® is displayed on top of a shape object, so that part of the shape may be hidden by the QR Code®. The importance of visibility of the shape object is considered to be low because it is often not difficult for the user to understand content of the shape object even if a part of the shape is missing. Thus, the QR Code® display adjustment processing unit 1108 does not move the QR Code® in a case where the object category information is the shape object information.

Further, in a case where the object category information is the image object information, the QR Code® is displayed on top of an image object, so that part of the image may be hidden by the QR Code®. The image object herein may contain a subject (or a specific object). The subject can be, for example, a person, an animal other than persons, or a specific background. Thus, the importance of visibility of the subject in the image is considered to be high because it often becomes difficult for the user to recognize the subject in the image if a part of the subject in the image is missing. Thus, the QR Code® display adjustment processing unit 1108 moves the QR Code® in a case where the object category information is the image object information and it is determined that the QR Code® overlaps the subject in the image object.

Specifically, in a case where there is a plurality of objects overlapping the QR Code®, the QR Code® display adjustment processing unit 1108 moves the QR Code® based on the importance of visibility of the objects so that the QR Code® does not overlap at least a predetermined object with high importance of visibility. Specifically, in a case where the object overlapping the QR Code® is a predetermined object with low importance of visibility, the QR Code® display adjustment processing unit 1108 permits the QR Code® to be displayed on top of the predetermined object. Instead of displaying a QR Code® on top of a predetermined object in all cases where the importance of visibility of the predetermined object is low, the QR Code® can be moved to not overlap the object with low importance of visibility in a case where content does not include any object with high importance of visibility. For example, in a case where image objects 1 and 2 overlap a QR Code®, the position of the QR Code® can be moved to not overlap the image objects 1 and 2. Further, priority can be given to objects with low importance of visibility, and an object with high priority among the objects with low importance of visibility can be controlled preferentially to not overlap the QR Code®.

Next, the movement necessity determination processing (auto) performed in step S1403 in FIG. 8 will be described in detail with reference to FIG. 9.

In step S1501, the QR Code® display adjustment processing unit 1108 determines whether there is an object overlapping the QR Code® in target document data. Specifically, whether the QR Code® overlaps another object is determined based on coordinates information about the document. The processing is performed on all objects contained in the document data. In a case where the determination result in step S1501 is YES (YES in step S1501), the processing proceeds to step S1502, whereas in a case where the determination result in step S1501 is NO (NO in step S1501), the process in the flowchart is ended. In step S1501, the determination of whether an object in the document overlaps the QR Code® is performed. Thus, in a case where the determination on all objects in the document is finished, the process in the flowchart is ended.

In step S1502, the QR Code® display adjustment processing unit 1108 acquires category information (hereinafter, “object category information”) about the object overlapping the QR Code®.

In step S1503, the QR Code® display adjustment processing unit 1108 determines whether the object category information about the object overlapping the QR Code® indicates a text object based on the object category information acquired in step S1502. In a case where the determination result in step S1503 is YES (YES in step S1503), the processing proceeds to step S1508, whereas in a case where the determination result in step S1503 is NO (NO in step S1503), the processing proceeds to step S1504.

In step S1504, the QR Code® display adjustment processing unit 1108 determines whether the object category information about the object overlapping the QR Code® indicates a shape object based on the object category information acquired in step S1502. In a case where the determination result in step S1504 is YES (YES in step S1504), the processing returns to step S1501, whereas in a case where the determination result in step S1504 is NO (NO in step S1504), the processing proceeds to step S1505.

In step S1505, the QR Code® display adjustment processing unit 1108 determines whether the object category information about the object overlapping the QR Code® indicates an image object based on the object category information acquired in step S1502. In a case where the determination result in step S1505 is YES (YES in step S1505), the processing proceeds to step S1506, whereas in a case where the determination result in step S1505 is NO (NO in step S1505), the processing returns to step S1501.

In step S1506, the QR Code® display adjustment processing unit 1108 identifies a subject position (coordinates) in the image. Identification of a subject in an image can be achieved using, for example, deep learning technologies. Further, in a case where it is determined that there is no subject in the image, the determination result in step S1507 is NO, and the processing returns to step S1501.

In step S1507, the QR Code® display adjustment processing unit 1108 determines, based on the subject position acquired in step S1506, whether the QR Code® and the subject in the image overlap each other. In a case where the determination result in step S1507 is YES (YES in step S1507), the processing proceeds to step S1508, whereas in a case where the determination result in step S1507 is NO (NO in step S1507), the processing returns to step S1501.

In step S1508, the QR Code® display adjustment processing unit 1108 turns on the movement flag of the object that is currently being processed, and the processing returns to step S1501.

Next, the movement necessity determination processing (custom) performed in step S1404 in FIG. 8 will be described with reference to FIG. 10. In the movement necessity determination processing (custom) according to the present exemplary embodiment, whether to move the QR Code® is determined based on settings of the object setting checkboxes in the QR Code® overlay placement permission setting dialog 1700 illustrated in FIG. 20.

Steps S1601 and S1602 respectively correspond to steps S1501 and S1502 in FIG. 9, so that redundant descriptions thereof are omitted.

In step S1603, the QR Code® display adjustment processing unit 1108 determines whether the object is an object on which the QR Code® can be overlaid based on the object category information acquired in step S1602 by referring to the QR Code® overlay placement permission setting information about the object corresponding to object category information. In a case where the determination result in step S1603 is YES (YES in step S1603), the processing returns to step S1601, whereas in a case where the determination result in step S1603 is NO (NO in step S1603), the processing proceeds to step S1604.

Step S1604 corresponds to step S1508 in FIG. 9, so that a redundant description thereof is omitted.

While the text object, the shape object, and the image object are described above as objects that can overlap the QR Code® and are used in determining whether to move the QR Code® in the movement necessity determination processing (auto or custom) according to the present exemplary embodiment, this is not a limiting case. For example, the shape object can be divided further to include text object, shape (background) object, shape (clipart) object, shape (clipart on which a QR Code® cannot be overlaid) object, and image object in the object type. For example, in the movement necessity determination processing (auto), in a case where the object overlapping the QR Code® is the shape (background) object or the shape (clipart) object, the QR Code® movement flag is not turned on, whereas in a case where the object overlapping the QR Code® is the shape (clipart on which a QR Code® cannot be overlaid) object, the QR Code® movement flag is turned on.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-025857, filed Feb. 22, 2023, which is hereby incorporated by reference herein in its entirety.

What is claimed is:

1. A non-transitory computer-readable storage medium that stores a program for causing a computer of an information processing apparatus to execute:
reducing a size of content including a first object having a predetermined threshold being a lower limit value of size and a second object different from the first object; and
placing the first object so that the first object does not overlap the second object in a case where the first object having reached the predetermined threshold and the second object overlap each other by execution of the reducing.

2. The non-transitory computer-readable storage medium according to claim 1, wherein the predetermined threshold being the lower limit value of size of the first object is a value greater than a lower limit value for the second object.

3. The non-transitory computer-readable storage medium according to claim 1, wherein the first object is a two-dimensional barcode.

4. The non-transitory computer-readable storage medium according to claim 1, the program further causing the computer to execute displaying a screen indicating that content including the first object placed at an inappropriate position is displayed in a case where the first object and the second object overlap each other by execution of the reducing.

5. The non-transitory computer-readable storage medium according to claim 1, wherein the size of the content is a sheet size in a case where the content is printed and is a size set for the content by the program.

6. The non-transitory computer-readable storage medium according to claim 5, the program further causing the computer to execute receiving a change in the sheet size,
wherein the reducing and the placing the first object are executed by receiving an operation of changing the sheet size set for the content from a large size to a small size.

7. The non-transitory computer-readable storage medium according to claim 1, wherein the second object is a text object or an image object.

8. The non-transitory computer-readable storage medium according to claim 7, wherein, in a case where a subject of the image object overlaps the first object, in the placing the first object, the first object is placed so that the first object does not overlap the second object.

9. The non-transitory computer-readable storage medium according to claim 1, the program further causing the computer to execute placing the first object and the second object so that the first object and the second object overlap each other in a case where the second object is a shape object.

10. The non-transitory computer-readable storage medium according to claim 1, wherein the content is displayed on a display unit of the information processing apparatus.

11. The non-transitory computer-readable storage medium according to claim 10, the program further causing the computer to execute transmitting, to a printing device, a print instruction to print the displayed content.

12. The non-transitory computer-readable storage medium according to claim 1, wherein a setting screen in which a type of the second object on which the placing the first object is performed is set is displayed on a display unit of the information processing apparatus.

13. The non-transitory computer-readable storage medium according to claim 1, the program further causing the computer to execute determining whether the first object and the second object overlap each other by execution of the reducing,
wherein, in a case where the first object and the second object are determined to overlap each other by execution of the reducing in the determining, the placing the first object is executed so that the first object and the second object do not overlap each other.

14. The non-transitory computer-readable storage medium according to claim 1, wherein, in a case where a plurality of second objects overlaps the first object by execution of the reducing, the placing the first object places the first object based on importance of visibility of the second objects so that the first object does not overlap at least a second object with high importance of visibility.

15. The non-transitory computer-readable storage medium according to claim 14, wherein an object with low importance of visibility is a shape object.

16. The non-transitory computer-readable storage medium according to claim 14, wherein an object with low importance of visibility is an image object containing a subject that does not overlap.

17. A non-transitory computer-readable storage medium that stores a program for causing a computer of an information processing apparatus to execute:
receiving a change instruction to change a sheet size of content containing a predetermined object;
performing adjustment processing of changing the sheet size of the content and adjusting a size and a position of the predetermined object contained in the content by receiving the change instruction to change the sheet size; and
changing a position of a first object placed in the adjustment processing in a case where the first object having a lower limit value of size is reduced to the lower limit value by reduction of the first object in the adjustment processing.

18. An information processing apparatus comprising:
a reduction unit configured to reduce a size of content including a first object having a predetermined threshold being a lower limit value of size and a second object different from the first object; and
a first placement unit configured to place the first object so that the first object does not overlap the second object in a case where the first object having reached the predetermined threshold and the second object overlap each other by reduction performed by the reduction unit.
